(19) United States
(12) Patent Application Publication
(10) Pub. No.: US 2006/0075861 A1
(43) Pub. Date: Apr. 13, 2006

(54) Film cutter

(76) Inventors: Daniel Leonard Flooding, Alexandria, MN (US); Paul Howard Wagner, Alexandria, MN (US); Ronald Matthew Gust, Miltona, MN (US); Irvan Leo Pazdernik, Alexandria, MN (US); Richard Jerome Schoeneck, Alexandria, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 10/960,238

(22) Filed: Oct. 7, 2004

(51) Int. Cl. B26D 7/06

(52) U.S. Cl. 83/436.3

(57) ABSTRACT

A cutting apparatus for cutting shrink wrap film residing in a roll. The apparatus includes a first roller pair receiving the film from the roll and carrying the film away from the roll; a second roller pair receiving the sheet of film from the first roller pair and carrying the film away from the first roller pair; a mechanism for providing an air stream to direct the leading edge of the film into the second roller pair; a mechanism for regulating the pressure exerted by the second roller pair against the sheet of film to maintain tension on the film between the first roller pair and the second roller pair; and a rotating blade to cut the film as the film exits the first roller pair, thereby producing a cut sheet of film. The apparatus may also include intermediate supports to prevent roller deflection, thus allowing the use of light-weight rollers to minimize inertia. A method for cutting a sheet of shrink wrap film, including: feeding the film into a first roller pair; feeding the film from the first roller pair into a second roller pair; regulating the pressure exerted by the second roller pair on the film so as to prevent slack from developing in the film without fully tensioning the film; and cutting the film between the first roller pair and the second roller pair.

### BACKGROUND OF THE INVENTION

The present invention generally relates to shrink wrap packaging apparatus and in particular to an apparatus for cutting shrink wrap film prior to the shrink wrapping operation.

In single roll shrink wrapping, a single sheet of shrink wrap film is wrapped around the product and into a tubular form. The overlapping lateral edges are located beneath the product and are sealed or otherwise joined together. During shrinking in a heat tunnel, the longitudinal edges of the shrink wrap film collapse against the ends of the product creating bullseye-type openings.

Various deficiencies exist in prior shrink wrap packaging and the methods of its fabrication. The single sheet of shrink wrap film was typically cut from a supply roll of the film. A common manner to cut the sheet from the web of film was to engage the film with a hot iron to melt the film and thus sever the sheet from the film. This hot iron is a high wear component and is always a source of operational problems. Another approach is to utilize a rotary blade which cuts the film. However, this approach experienced problems that the new leading edge of the web of film did not continue to follow the desired path of the film as a result of the velocity of the film and air resistance, the memory of the film, and/or the snap back of the film when the tension was released on the film because of cutting. These problems were overcome by cutting the film while the film is held across the cut and/or by including mechanical devices which grasp and pull the new leading edge, but such approaches unduly complicated the construction of the apparatus. Thus, there continues to be a need for feeding the film after a sheet is cut from the free end thereof which overcomes the deficiencies of the current approaches.

U.S. Pat. No. 5,771,662 (Struges et.al.), herein incorporated by reference, discloses an apparatus and methods for producing shrink wrap packaging. However, the Struges patent does not fully overcome the deficiencies of prior approaches, particularly in the area of cutting the film. Struges requires a vacuum table at the exit from the nip rollers to hold the film for further processing. The vacuum table is an expensive and complex piece of equipment which is not necessary for lower-speed operation. In addition, Struges requires a cutting blade that cuts tie strips into the film that allow the trailing edge of a single sheet of film which is downstream from the cut to remain connected to a new leading edge for the web of film which is upstream from the cut, so that the single sheet of film remains attached to the web of film thereby pulling the leading edge of the web of film toward and through the downstream pinch rollers 14 and 15 and to maintain tension of film between the upstream pinch rollers 12 and 13 and the downstream pinch rollers 14 and 15 and to ensure that the new leading edge of the web of film follows the desired path to the downstream pinch rollers.

The present invention overcomes the above deficiencies.

### SUMMARY OF THE INVENTION

A cutting apparatus for cutting shrink wrap film residing in a roll. The apparatus includes a first roller pair receiving the film from the roll and carrying the film away from the roll; a second roller pair receiving the sheet of film from the first roller pair and carrying the film away from the first roller pair; a mechanism for providing an air stream to direct the leading edge of the film into the second roller pair; a mechanism for regulating the pressure exerted by the second roller pair against the sheet of film to maintain tension on the film between the first roller pair and the second roller pair; and a rotating blade to cut the film as the film exits the first roller pair, thereby producing a cut sheet of film. A method for cutting a sheet of shrink wrap film, including: feeding the film into a first roller pair; feeding the film from the first roller pair into a second roller pair; regulating the pressure exerted by the second roller pair on the film so as to prevent slack from developing in the film without fully tensioning the film; and cutting the film between the first roller pair and the second roller pair.

A principal object and advantage of the present invention is that it eliminates the expense and complication of a vacuum table.

Another principal object and advantage of the present invention is that it eliminates tie strips cut into some kinds of film to feed the film into the second roller pair and maintain film tension.

Another principal object and advantage of the present invention is that it uses a stream of air to guide the leading edge of the film into the second roller pair.

Another principal object and advantage of the present invention is that it uses variable pressure between the second roller pair to vary film tension just prior and just after cutting the film, thus minimizing film snap-back.

### BRIEF DESCRIPTION OF DRAWINGS

FIG. 1 is an exploded perspective view of the apparatus of the present invention.

FIG. 2 is a front elevational view of the apparatus of the present invention.

FIG. 3 is a top plan view of the apparatus of the present invention.

FIG. 4 is a schematic cross-section taken at approximately the lines 4 in FIG. 3.

FIG. 5 is a flowchart of the method of the present invention.

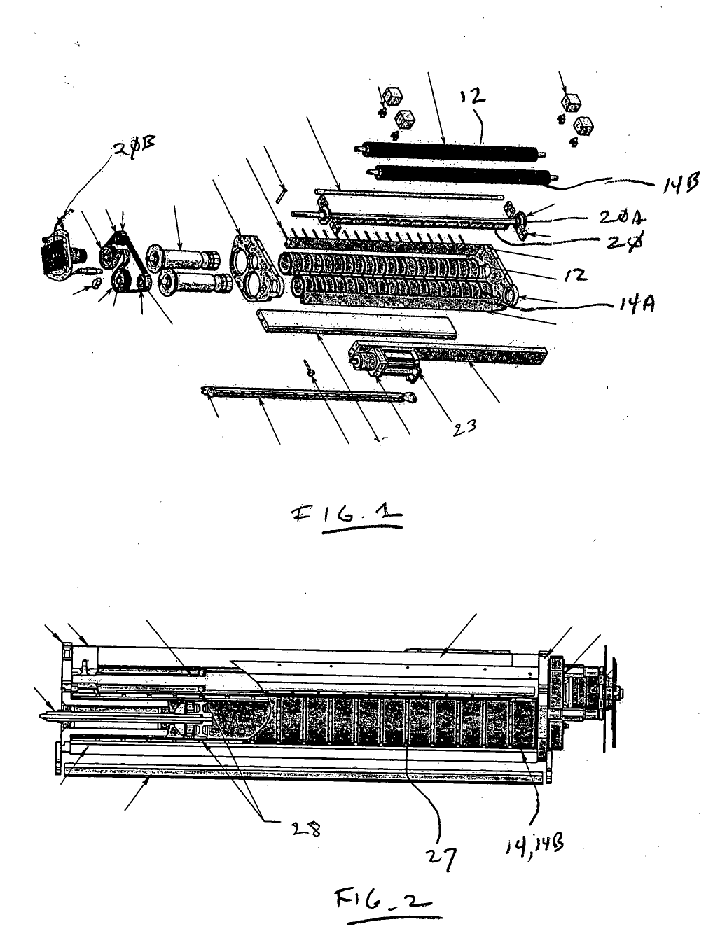

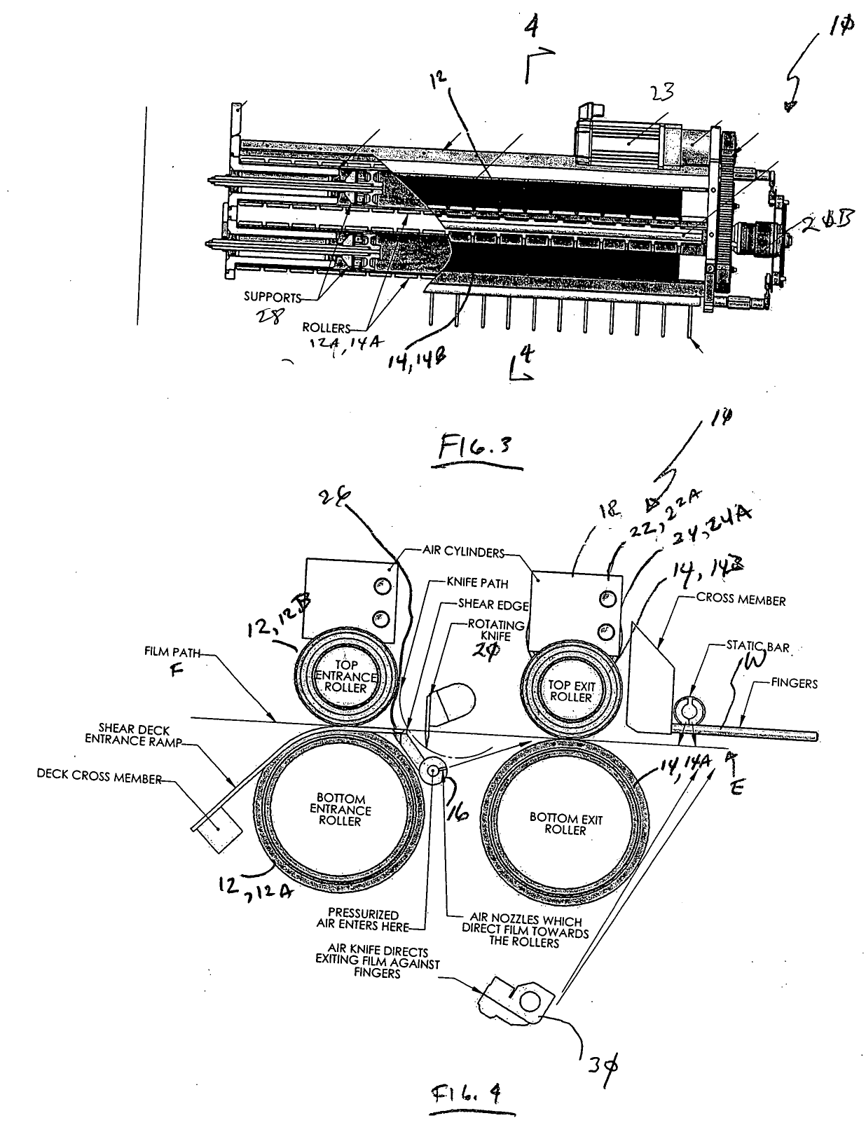

### DETAILED DESCRIPTION OF THE PREFERRED EMBODIMENT

The present invention is a cutting apparatus and method for cutting shrink wrap film and is generally shown in the drawings as reference numeral 10.

The apparatus 10 comprises a first roller pair 12 adapted to receive the film F from its roll (not shown) and to carry the film F away from the roll. The apparatus 10 further comprises a second roller pair 14 adapted to receive the sheet of film F from the first roller pair 12 and carry the film away from the first roller pair. The apparatus 10 further comprises a mechanism 16 for providing an air stream adapted to direct the leading edge E of the film F into the second roller pair 14. The apparatus 10 further comprises a mechanism 18 for regulating the pressure exerted by the second roller pair against the sheet of film F thereby maintaining tension on the film between the first roller pair 12 and the second roller pair. 14. The apparatus 10 further comprises a rotating blade 20 adapted to cut the film as the film exits the first roller pair, thereby producing a cut sheet of film.

In one embodiment, the second roller pair further comprises a driven roller 14A and a non-driven roller 14B engaging the driven roller, and further comprises a mechanism 22 pressing the non-driven roller 14B against the driven roller 14A and producing a variable pressure between the non-driven roller 14B and the driven roller 14A. The first roller pair may also comprise a driven roller 12A and a non-driven roller 12B. The driven roller in each pair is preferably belt driven by a servomotor 23. The first roller pair preferably has the non-driven roller 12B pressed against the driven roller 12A by air pressure. This air pressure can be set by the operator to consistently pull the film F from the roll without slippage, depending on the thickness and quality of the film F.

The apparatus 10 may also preferably comprise a mechanism 24 separating the non-driven roller 14B from the driven roller 14A.

The apparatus 10 may also preferably comprise a means (not shown) for coordinating the mechanism 22 and the mechanism 24 whereby the resultant pressure between the non-driven roller 14B and the driven roller 14A can be varied. The means for coordinating may be any programmable means such as a digital computer or a PLC.

Preferably the mechanism 22 and the mechanism 24 are driven by air pressure, and the air pressure is varied through regulators (not shown) to control air cylinders 22A and 24A. It should be noted that a single air cylinder may be used to provide both the mechanism 22 and the mechanism 24.

Preferably, the second roller pair 14 is geared to rotate a speed somewhat faster than the rotational speed of the first roller pair, which provides a way of stretching the film to enhance the cutting action of the knife 20. The second roller pair may rotate 1% to 5% faster. Most preferably, the second roller pair is geared to rotate about 3.6% faster than the first roller pair.

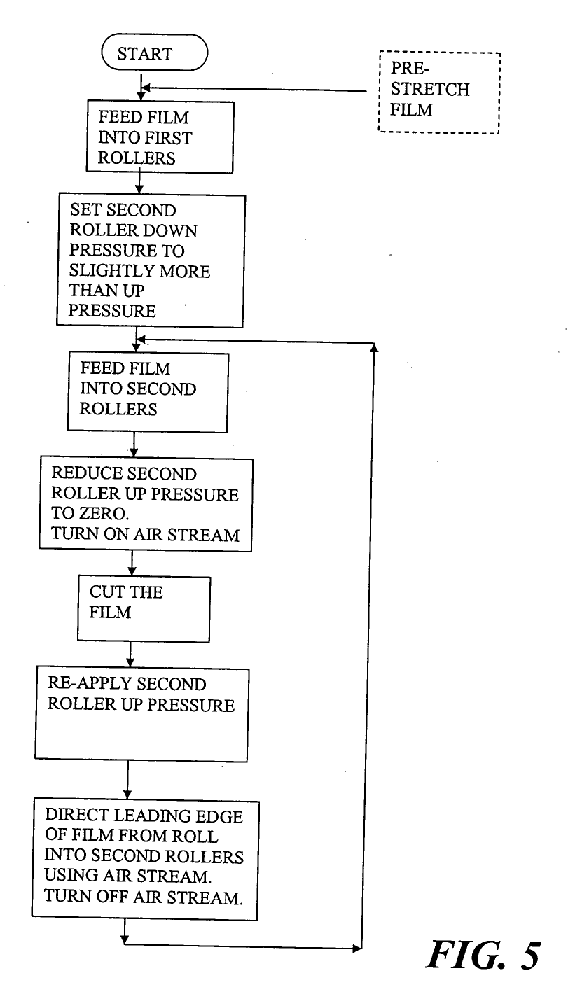

Operation of the apparatus and a description of the method will now be described, referring to FIGS. 4 and 5.

Optionally, the tension on the film F being fed into the first roller pair may be increased to pre-stretch and flatten the film. For example, this may be done by dancer bars (which are illustrated in the Struges patent).

The film F enters the first roller pair 12. The mechanism or air nozzles 16 then directs a stream of air against the leading edge E of the film, guiding the leading edge E into the second roller pair 14.

The air pressure applied to the second roller pair 14 is varied during each cutting cycle. Pressurized air is supplied to the air cylinders 22A and 24A controlling the force exerted to hold the non-driven roller 14B against the driven roller 14A. At the start of the cycle, the air pressure forcing the rollers 14 together (down pressure) is slightly more than the pressure that would move the rollers apart (up pressure). This balance of air pressures allows the rollers 14 to grip the film surface and feed film received from the rollers 12 into the wrapping area W without allowing any slack to develop in the film.

Because the rollers 14 rotate faster than the rollers 12, the film slips on the surface of the driven roller 14A. Prior to cutting the film, the up pressure on the roller 14B is reduced to zero. This eliminates the slippage between the film and the driven roller 14A. The film is pulled taut prior to being cut by the knife 20. As the film is cut and begins to separate, the up pressure to roller 14B is re-applied. This reduces film tension and minimizes film “snap back.” This enhances the ability of the air knife 16 to guide the film leading edge E into the rollers 14 for the next cutting cycle.

The knife 20 is positioned just above the film and between the pairs of rollers 12 and 14. The knife is mounted on a shaft 20A that rotates in the same direction as the film travel. A clutch 20B is mounted on the knife shaft 20A. When the clutch engages, the knife swings in an arc, contacting and cutting the film.

A steel deck 26 is positioned between the rollers 12 and the knife 20 and just outside the knife arc. This deck provides a shear point to enhance the cutting action of the knife.

After the film is cut, the leading edge E of the cut film is directed and supported by streams of air from air nozzles 16 located in the deck support structure. These air nozzles are aligned with relief grooves 27 in the downstream driven roller 14A. The air stream flowing from each nozzle and through a relief groove creates a venturi effect. This venturi effect at each relief groove aids in directing the leading edge of the film between the downstream rollers 14A and 14B.

An air knife 30 mounted downstream of the second rollers 14, guides the film leading edge into the proper position for wrapping around the product.

Preferably, the rollers 12 and 14 are supported at intermediate points along their length by supports 28, thus preventing deflection. This is important in order to allow very light weight rollers to be used to reduce inertia.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A cutting apparatus for cutting shrink wrap film, the film residing in a roll, comprising:
(a) a first roller pair adapted to receive the film from the roll and carry the film away from the roll;
(b) a second roller pair adapted to receive the sheet of film from the first roller pair and carry the film away from the first roller pair;
(c) a mechanism for providing an air stream adapted to direct the leading edge of the film into the second roller pair;
(d) a mechanism for regulating the pressure exerted by the second roller pair against the sheet of film thereby maintaining tension on the film between the first roller pair and the second roller pair; and
(e) a rotating blade adapted to cut the film as the film exits the first roller pair, thereby producing a cut sheet of film.

2. The apparatus of claim 1, wherein the second roller pair further comprises a driven roller and a non-driven roller engaging the driven roller, further comprising a mechanism pressing the non-driven roller against the driven roller and producing a variable pressure between the non-driven roller and the driven roller.

3. The apparatus of claim 2, further comprising a mechanism separating the non-driven roller from the driven roller.

4. The apparatus of claim 3, further comprising means for coordinating the mechanism pressing the non-driven roller against the driven roller and the mechanism separating the non-driven roller from the driven roller, whereby the resultant pressure between the non-driven roller and the driven roller can be varied.

5. The apparatus of claim 4, wherein the mechanism pressing the non-driven roller against the driven roller and the mechanism separating the non-driven roller from the driven roller are driven by air pressure.

6. The apparatus of claim 2 wherein the non-driven rollers have intermediate supports along their length.

7. The apparatus of claim 2, wherein the driven rollers have intermediate supports along their length.

8. The apparatus of claim 1, further comprising a cutting deck between the first roller pair and the second roller pair, wherein the film is sheared between the cutting deck and the rotating blade.

9. The apparatus of claim 1, wherein the second roller pair has a plurality of grooves and wherein the mechanism for providing an air stream creates a venturi effect in the grooves.

10. A method for cutting a sheet of shrink wrap film, comprising the steps of:
(a) feeding the film into a first roller pair;
(b) regulating the pressure exerted by the second roller pair on the film so as to prevent slack from developing in the film without fully tensioning the film;
(c) feeding the film from the first roller pair into a second roller pair; and
(d) cutting the film between the first roller pair and the second roller pair.

11. The method of claim 10, wherein step (b) further comprises exerting slightly more pressure forcing the rollers together than pressure forcing the rollers apart.

12. The method of step 11, further comprising the step of momentarily reducing the pressure forcing the rollers apart to zero just prior to step (d), thus keeping the film taut.

13. The method of claim 12, further comprising the step (e) of re-applying the pressure forcing the rollers apart, thus reducing film tension and minimizing film snap-back.

14. The method of claim 13, further comprising the step (f) of directing the leading edge of the film between the second roller pair using a stream of air.

15. The method of claim 10, further comprising the step of increasing the tension on the film feeding into the first roller pair prior to step (a), thereby pre-stretching and flattening the film.

16. The method of claim 14, wherein the second roller pair has a plurality of grooves, and further comprising the step of creating a venturi effect in the grooves with the stream of air.

17. The method of claim 10, further comprising the step of preventing deflection in the first roller pair and second roller pair.
